(19) United States
(12) Patent Application Publication
(10) Pub. No.: US 2025/0337193 A1
(43) Pub. Date: Oct. 30, 2025

(54) ELECTRICAL CONNECTOR AND ENERGY STORAGE SYSTEM

(71) Applicant: Sungrow Power Supply Co., Ltd., Hefei (CN)

(72) Inventors: Jian Guo, Hefei (CN); Jianjie Zhou, Hefei (CN)

(73) Assignee: Sungrow Power Supply Co., Ltd., Hefei (CN)

(21) Appl. No.: 18/995,704

(22) PCT Filed: Jun. 13, 2023
(86) PCT No.: PCT/CN2023/099841

§ 371 Date: Jan. 16, 2025

(30) Foreign Application Priority Data
Nov. 11, 2022 (CN) 202223008653.3

(51) Int. Cl. H01R 13/627; H01R 13/635; H01R 13/639; H01R 13/645

(52) U.S. Cl. CPC H01R 13/6275; H01R 13/635; H01R 13/639; H01R 13/6456

(57) ABSTRACT

An electrical connector includes: a receptacle having a mating socket and a device-side interface, the device-side interface being configured to be electrically connected to an electrical apparatus and secured to the electrical apparatus; and a plug, provided with an electrical plug and a wire interface. The receptacle and the plug can be plugged together by means of the cooperation between the mating socket and the electrical plug; the wire interface is configured to be electrically connected to a wire; the plug is configured to have a pre-plugged state so as to be in insulating connection with the receptacle, and to have an electrically-plugged state so as to be in electrical connection with the receptacle; in the pre-plugged state, the plug is detachably connected to the receptacle. The electrical connector provided by the technical solution of the present application can solve the problems of erroneous plugging and misplug.

This application is a national stage filing under 35 U.S.C. § 371 of International Patent Application Serial No. PCT/CN2023/099841, filed Jun. 13, 2023, which claims the priority to Chinese Patent Application No. 202223008653.3, titled “ELECTRICAL CONNECTOR AND ENERGY STORAGE SYSTEM”, filed with the China National Intellectual Property Administration on Nov. 11, 2022. The contents of these applications are incorporated herein by reference in their entirety.

### FIELD

The present application relates to the technical field of electrical accessories, and in particular, to an electrical connector and an energy storage system.

### BACKGROUND

With the rapid development of the energy storage industry, a wire assembly in an energy storage system often carries a large current, and a plug in the wire assembly can cooperate with a receptacle to realize a rapid connection in the system, which has the technical advantages of high efficiency and reliability. However, with the rapid development of the industry, there are specific use requirements for the wire assembly in different situations.

At present, in the process of production, transportation and installation of the energy storage system, before the energy storage system is delivered from a factory, the wire assembly in the energy storage system is disassembled, that is, the plug and the receptacle are separated, in order to keep the installer and the whole system safe. Then, the plug and the wire, the receptacle and the electrical device are respectively packaged and delivered. After arriving at the site, the wire assembly is required to be connected by the installer, that is, the plug is plugged into the receptacle before the whole machine is debugged. Finally, a whole high-voltage circuit is successfully connected. However, in the actual construction operation on the site, on one hand, since the high-voltage loop in the energy storage system is relatively complex, there are many plugs and receptacles that need to be connected, and the plug only has an electrically-plugging port that can be electrically connected to the receptacle and a wire interface that can be connected to a cable, so wrong plugging and mis-plugging are prone to occur, for example, a plug that should be plugged into the third row of receptacles is plugged into the second row of receptacles. On the other hand, due to the uneven experience and professionalism of the on-site installers, there is not enough time to provide systematic installation training to the installers. This may lead to wrong plugging and mis-plugging by the installers in the actual operation, so that a short-circuit accident of the system is easily caused, thereby resulting in economic losses and greatly increasing the safety risks of the on-site installers.

### SUMMARY

A main object of the present application is to provide an electrical connector and an energy storage system, which can solve the occurrence of wrong plugging and mis-plugging in the existing installation process.

In order to achieve the above object, according to one aspect of the present application, an electrical connector is provided, including a receptacle and a plug. The receptacle has a mating port and a device-side interface, and the device-side interface is configured to be electrically connected to an electrical device and secured to the electrical device; the plug has an electrically-plugging port and a wire interface. The receptacle and the plug can be plugged together by means of the cooperation of the mating port and the electrically-plugging port, the wire interface is configured to be electrically connected to a wire, and the plug is configured to have a pre-plugging state in which the plug is in an insulating connection with the receptacle, and an electrically-plugging state in which the plug is in electrical connection with the receptacle. In the pre-plugging state, the plug is detachably connected to the receptacle.

According to another aspect of the present application, an energy storage system is provided, including an electrical device, a wire, and the above-mentioned electrical connector, and multiple plugs and multiple receptacles are provided in one-to-one correspondence.

In applying the technical solutions of the present application, the structure of the plug is changed, so that the plug can be plugged into the receptacle to be in the pre-plugging state or the electrically-plugging state. Before the energy storage system is delivered, a plug is plugged into its corresponding receptacle to be in the pre-plugging state, which is an insulating-connection state, and there is no electrical conductivity and no danger in this state. After the energy storage system is delivered to the site, the plug is unplugged from the receptacle, and then the plug is plugged into its corresponding receptacle again to be in the electrically-plugging state, which is the electrically-connection state. The two states can be switched before and after delivery, so as to ensure safety during delivery. An installer on site only needs to unplug a certain plug from its corresponding receptacle, then plug the plug into its corresponding receptacle again to be in the electrically-plugging state. It is unnecessary to look for a receptacle corresponding to a certain plug, thereby reducing the occurrence of wrong plugging and mis-plugging, reducing the short-circuit accident in the system, the economic loss, and the safety risk.

### BRIEF DESCRIPTION OF THE DRAWINGS

The accompanying drawings constituting a part of the present application are used to provide a further understanding of the present application. Exemplary embodiments of the present application and the description thereof are used to explain the present application, and do not constitute an improper limitation on the present application. Wherein:

FIG. 1 is a structural schematic view of an electrical connector according to a first embodiment of the present application;

FIG. 2 shows a cross-sectional view of a plug in FIG. 1 (in which L1 is a first preset axis);

FIG. 3 shows a cross-sectional view of the plug and receptacle of FIG. 1 in a pre-plugging state;

FIG. 4 shows a cross-sectional view of the plug and receptacle of FIG. 1 in an electrically-plugging state;

FIG. 5 is a structural schematic view of an electrical connector according to a second embodiment of the present application;

FIG. 6 shows a cross-sectional view of a plug and a receptacle of FIG. 5 in a pre-plugging state;

FIG. 7 shows a cross-sectional view of the plug and the receptacle of FIG. 5 in an electrically-plugging state;

FIG. 8 shows a cross-sectional view of the plug of FIG. 5;

FIG. 9 is a structural schematic view of an electrical connector according to a third embodiment of the present application;

FIG. 10 is a structural schematic view of FIG. 9 from another viewpoint;

FIG. 11 shows a cross-sectional view of a plug and a receptacle of FIG. 9 in a pre-plugging state;

FIG. 12 shows a cross-sectional view of the plug and the receptacle of FIG. 9 in an electrically-plugging state; and

FIG. 13 shows a front view of an energy storage system according to the present application.

Reference numerals in the accompanying drawings are explained as follows:

| | |
|---|---|
| 10. receptacle; | 101. mating port; |
| 102. device-side interface; | 103. buckle; |
| 131. pre-plugging limiting portion; | |
| 132. electrically-plugging guiding | |
| portion; | |
| 104. identification strip; | 20. plug; |
| 201. electrically-plugging port; | 211. electrically-plugging slot; |
| 221. first slot section; | 222. second slot section; |
| 202. wire interface; | 203. pre-plugging port; |
| 212. pre-plugging slot; | 213. first pre-plugging latch; |
| 214. first electrically-plugging latch; | 215. first unlocking member; |
| 223. second pre-plugging latch; | 224. second electrically-plugging |
| | latch; |
| 225. latching structure; | 226. second unlocking member; |
| 231. limiter; | 232. guide slot; |
| 233. guide gap; | 30. electrical device; |
| 40. wire. | |

### DETAILED DESCRIPTION OF THE EMBODIMENTS

It should be noted that the embodiments in the present application and the features in the embodiments may be combined with each other without conflict. The present application will be described in detail below with reference to the accompanying drawings and in conjunction with the embodiments.

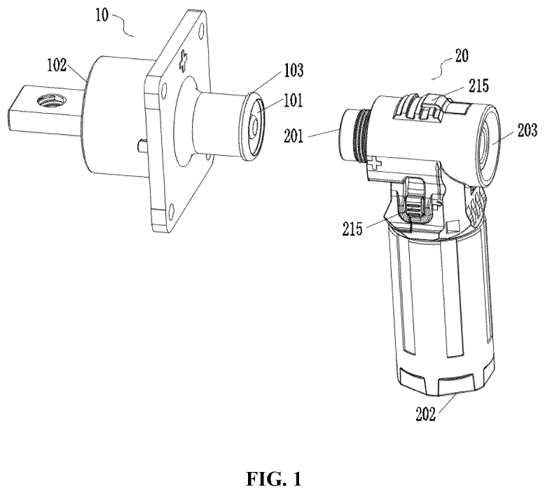

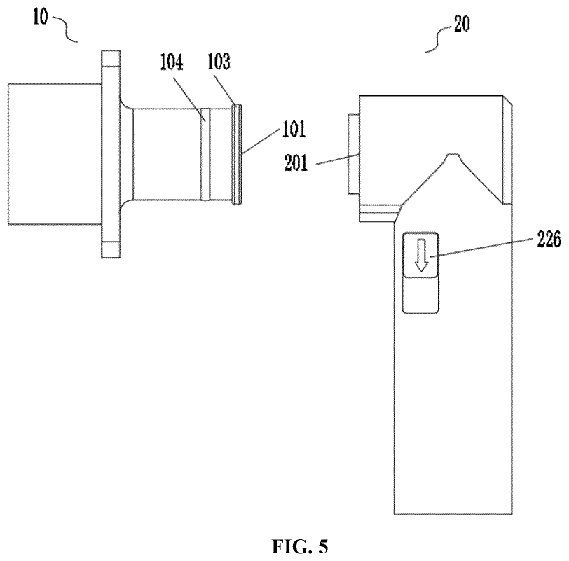

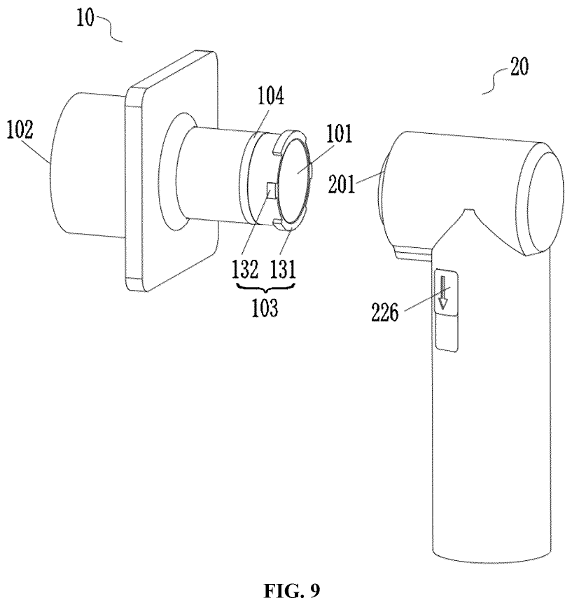

Referring to FIG. 1, FIG. 5 and FIG. 9, the present application provides an electrical connector. The electrical connector includes a receptacle 10 and a plug 20. The receptacle 10 has a mating port 101 and a device-side interface 102, the device-side interface 102 is configured to be electrically connected to the electrical device 30 and secured to the electrical device 30. The plug 20 has an electrically-plugging port 201 and a wire interface 202. The plug 20 can be plugged into the receptacle 10 by the mating plugging port 101 and the electrically plugging port 201, and the wire interface 202 is configured to be electrically connected to a wire 40, and the plug 20 is configured to have a pre-plugging state in which the plug 20 is in an insulating connection with the receptacle 10, and an electrically-plugging state in which the plug 20 is in an electrical connection with the receptacle 10.

In one embodiment, the electrical device 30 is a battery pack, and the wire 40 is a high-voltage cable.

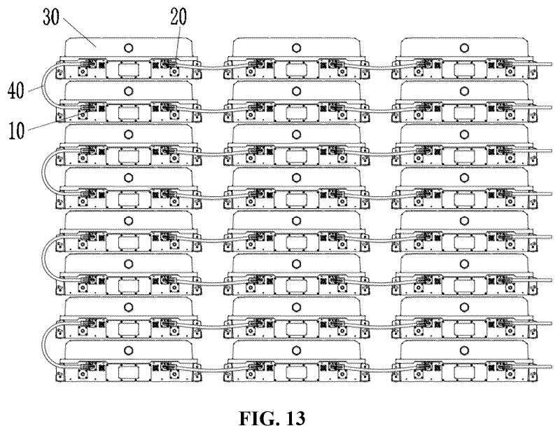

In the above technical solution, through different plugging positions or modes, the plug 20 and the receptacle 10 can have two plug-in connection states to respectively form the insulating connection and the electrical connection. With reference to FIG. 13, in an actual application, multiple plugs 20 and multiple receptacles 10 are provided, and the multiple plugs 20 respectively correspond to the multiple receptacles 10. Before an energy storage system is delivered, the multiple plugs 20 can be plugged into the multiple receptacles 10 to be in the pre-plugging state. After the energy storage system is delivered to the site, each plug 20 can be unplugged from its receptacle 10, and then plugged into its receptacle 10 to be in the electrical connection state.

Through the above arrangement, an installer is only required to unplug one plug 20 from its receptacle 10, and then plug it into its receptacle 10 again to be in the electrical connection state. Each plug 20 and its receptacle 10 can be connected in the pre-connection state and the electrical-connection state, so that the installer does not need to look for the receptacle 10 special for the certain plug 20, thereby reducing the occurrence of wrong plugging and mis-plugging.

### First Embodiment

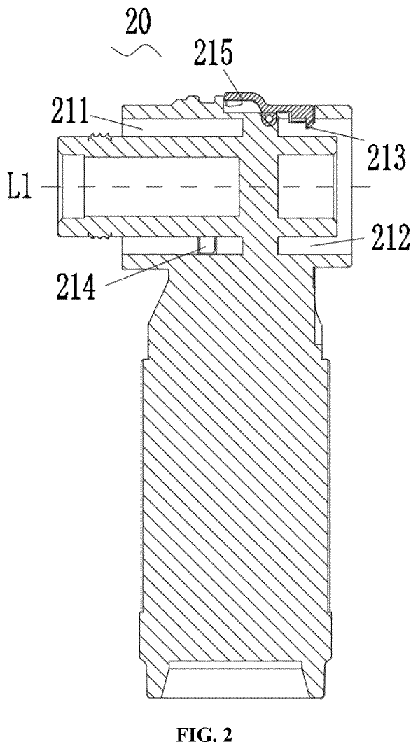

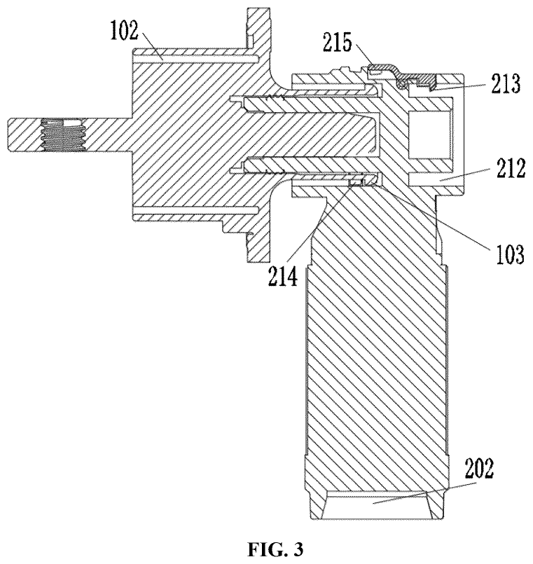

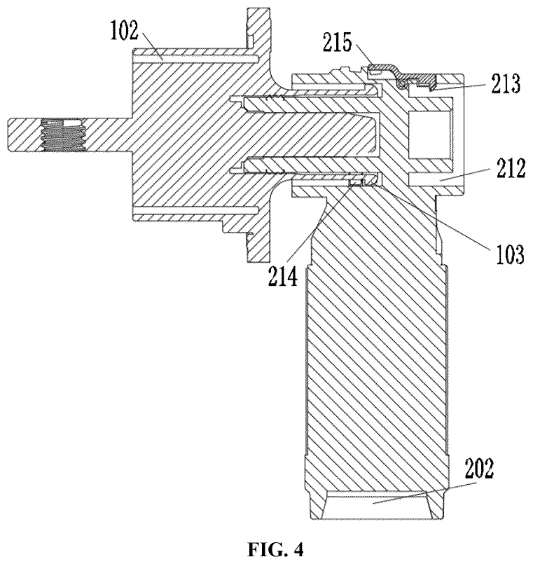

Referring to FIG. 1 to FIG. 4, in a first embodiment of the present application, the plug 20 further has a pre-plugging port 203, which is made of an insulating material and configured to be plugged into the receptacle 10 so as to reach the pre-plugging state.

In the above technical solution, after the pre-plugging port 203 is plugged into the mating port 101, the pre-plugging port 203 cannot be electrically connected to the mating port 101, i.e., the pre-plugging port 203 is connected to the mating port 101 to be in the pre-plugging state due to the insulation of the pre-plugging port 203, and the electrically-plugging port 201 is provided to be opposite to the pre-plugging port 203. After the pre-plugging port 203 is unplugged from the mating port 101, the plug 20 can be rotated in a radial direction by 180°, and the electrically-plugging port 201 faces the mating port 101. At this time, the electrically-plugging port 201 can be plugged into the mating port 101 to be in the electrically-plugging state. The pre-plugging port 203 is provided with a pre-plugging slot 212 in a length direction (i.e. a first axis direction), and the mating port 101 is plugged into the pre-plugging port 203 by fitting the pre-plugging slot 212. An electrically-plugging slot 211 is provided in the electrically-plugging port 201 along the length direction, and the mating port 101 is plugged with the electrically-plugging port 201 by fitting into the electrically-plugging slot 211.

Through the above arrangement, the two ports can respectively form two plug-in states, which is simple to operate and easy to be understood and practically operated by the installer. The pre-plugging port 203 and the electrically-plugging port 201 together form a head of the plug 20, and the pre-plugging port 203 and the electrically-plugging port 201 are provided opposite to each other to facilitate the manufacturing of the plug 20. Each of the pre-plugging slot 212 and the electrically-plugging slot 211 is configured to provide a plugging space for the mating port 101.

Referring to FIG. 1 to FIG. 4, in the first embodiment of the present application, a buckle 103 is provided on the mating port 101, a first pre-plugging latch 213 is provided in the pre-plugging port 203, and a first electrically-plugging latch 214 is provided in the electrically-plugging port 201. The buckle 103 can be selectively latched onto the first pre-plugging latch 213 in a first locking position and latched onto the first electrically-plugging latch 214 in a second locking position.

In the above technical solution, the buckle 103 is an annular protrusion extending circumferentially along an edge of an end of the mating port 101, and the first pre-plugging latch 213 and the first electrically-plugging latch 214 are both blockers. In the process of plugging the mating port 101 into the pre-plugging port 203, the buckle 103 is moved in the pre-plugging slot 212 from a first side of the first pre-plugging latch 213 to a second side of the first pre-plugging latch 213, at this point, the buckle 103 is in the first locking position; and at this time, the buckle 103 is latched onto the first pre-plugging latch 213, and a pre-plugging state is formed. In the process of plugging the mating port 101 into the electrically-plugging port 201, the buckle 103 is moved in the electrically-plugging slot 211 from a first side of the first electrically-plugging latch 214 to a second side of the first electrically-plugging latch 214, at this point, the buckle 103 is in the second locking position. At this time, the buckle 103 is latched onto the first electrically-plugging latch 214, and an electrically-plugging state is formed.

Through the above arrangement, when the pre-plugging port 203 is plugged into the mating port 101, the first pre-plugging latch 213 cooperates with the buckle 103 so as to lock the plug 20 to the receptacle 10, and the plug 20 is prevented from detaching from the receptacle 10 due to an external force such as bumping or collision during delivery, which may otherwise make the pre-plugging port 203 lose the pre-plugging effect. After the mating port 101 is plugged into the electrically-plugging port 201, the first electrically-plugging latch 214 cooperates with the buckle 103 so as to lock the plug 20 to the receptacle 10, and the plug 20 is prevented from detaching from the receptacle 10 in the high-voltage conduction process to initiate an open-circuit fault of a system, thereby ensuring the stability of the system.

Referring to FIG. 1 to FIG. 4, in the first embodiment of the present application, a first unlocking member 215 is provided on an outer wall of the plug 20, and the first unlocking member 215 is provided to be rotatable relative to the outer wall of the plug 20. The first unlocking member 215 is connected to the first pre-plugging latch 213 and the first electrically-plugging latch 214, and the first unlocking member 215 is configured to unlock the buckle 103 by rotation.

In the above technical solution, two first unlocking members 215 are provided, one of the first unlocking members is connected to the first pre-plugging latch 213, and the other of the first unlocking members is connected to the first electrically-plugging latch 214. The outer wall of the plug 20 is provided with a first through-hole, which is communicated with the pre-plugging slot 212, and an angle is formed between an axis of the first through-hole and the first preset axis L1. The first pre-plugging latch 213 passes through the first through-hole and is located in the pre-plugging slot 212, the first unlocking member 215 is pivotally connected to the outer wall of the plug 20. The first pre-plugging latch 213 is located at a first end of the first unlocking member 215, a first end of the first unlocking member 215 is located in the first through-hole, and a second end of the first pre-plugging latch 213 is located on the outer wall of the plug 20. When a second end of the first unlocking member 215 is pressed, the first pre-plugging latch 213 is driven away from the pre-plugging slot 212 and out of the first through-hole due to the lever principle. At this time, the mating port 101 can move smoothly along the pre-plugging slot 212 without obstruction, i.e., the first pre-plugging latch 213 no longer has the locking function, and the mating port 101 can be pulled out or inserted into the pre-plugging slot 203. A spring is connected between the second end of the first unlocking member 215 and the outer wall of the plug 20. When the first unlocking member 215 is released, the spring returns to its original length to drive the first end of the first unlocking member 215 to enter into the first through-hole again. The structure and the operation principle of the first unlocking member 215 connected to the first pre-plugging latch 213 are respectively the same as those of the first unlocking member 215 connected to the first electrically-plugging latch 214.

The first electrically-plugging latch 214 has an inclined surface at an end thereof facing an opening of the electrically-plugging port 201, and the first pre-plugging latch 213 also has an inclined surface at an end thereof facing an opening of the pre-plugging port 203.

Through the above arrangement, when the mating port 101 is plugged into the pre-plugging port 203, the buckle 103 is in contact with the inclined surface of the first pre-plugging latch 213 and moves relative to the inclined surface of the first pre-plugging latch 213. The spring between the second end of the first unlocking member 215 and the outer wall of the plug 20 is compressed due to the lever principle, the first pre-plugging latch 213 passes out of the first through-hole, and the buckle 103 continues to move relative to the first pre-plugging latch 213 until the first pre-plugging latch 213 is latched onto the buckle 103, so that when the buckle 103 is connected to the first pre-plugging latch 213, it is unnecessary to press the first unlocking member 215 due to the spring, and the first pre-plugging latch 213 is unlocked by a thrust generated by the movement. When the mating port 101 is pulled out of the pre-plugging port 203, the first unlocking member 215 is pressed, after the mating port 101 is completely pulled out of the pre-plugging port 203, the first unlocking member 215 is released to ensure that the mating port 101 is successfully unplugged from the pre-plugging port 203. When the mating port 101 is plugged into the electrically-plugging port 201, the locking process of the buckle 103 and the first electrically-plugging latch 214 is the same as the locking process of the buckle 103 and the first pre-plugging latch 213; and the unlocking process of the buckle 103 and the first pre-plugging latch 213 is the same as the unlocking process of the buckle 103 and the first electrically-plugging latch 214.

In the first embodiment of the present application, an inner side of the electrically-plugging port 201 is made of an electrically conductive material or provided with an electrically conductive sheet.

Through the above arrangement, the electrically-plugging port 201 and the mating port 101 can be electrically connected to each other after they are connected together and powered on.

### Second Embodiment

The difference between the second embodiment and the first embodiment lies in that in the second embodiment, the plug 20 does not have a pre-plugging port 203, and the structure of the electrically-plugging port 201 is different from that of the first embodiment.

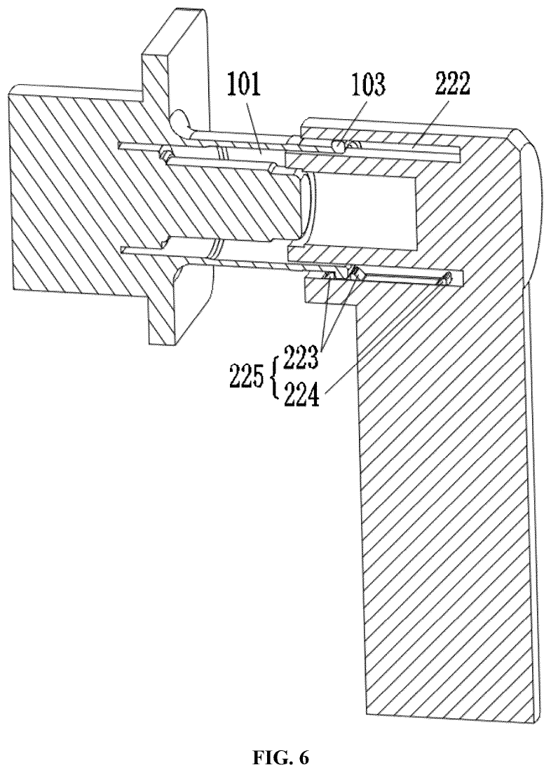

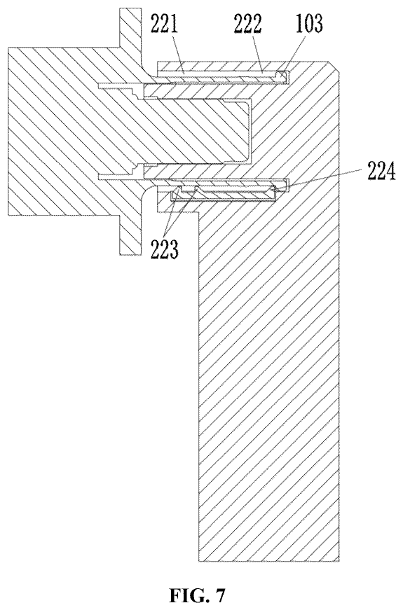

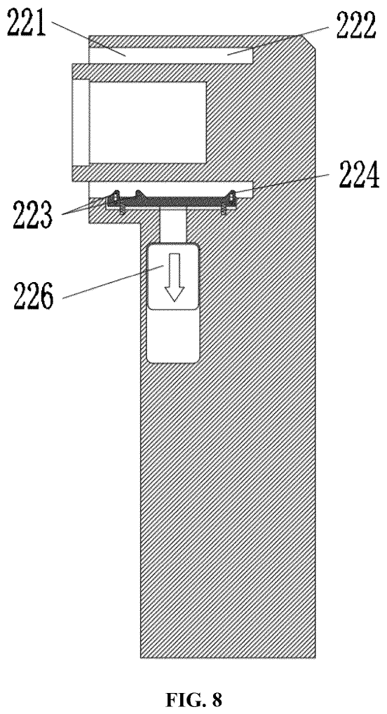

Referring to FIG. 5 to FIG. 8, in the second embodiment of the present application, the electrically-plugging port 201 has a first slot section 221 and a second slot section 222 that are communicated with each other, and the electrically-plugging port 201 can slidablely cooperate with the mating port 101, so that the mating port 101 is selectively plugged into the first slot section 221 and the second slot section 222, and the mating port 101 is plugged into the first slot section 221 to be in the pre-plugging state, and the mating port 101 is plugged into the second slot section 222 to be in the electrically-plugging state.

In the above technical solution, each of the first slot section 221 and the second slot section 222 is an annular slot, the first slot section 221 and the second slot section 222 are arranged in the radial direction of the electrically-plugging port 201, the first slot section 221 is located at a depth smaller than that of the second slot section 222 in the electrically-plugging port 201, and the mating port 101 is plugged into the first slot section 221 or the second slot section 222 due to different plugging depths respectively.

Through the above arrangement, when the mating port 101 and the electrically-plugging port 201 are required to switch from the pre-plugging state to the electrically-plugging state, it is only necessary to further plug the electrically-plugging port 201 into the mating port 101 in the same direction, so that the mating port 101 enters into the second slot section 222 from the first slot section 221, which is simple to operate and easy to be understood and practically operated by the installer.

Referring to FIG. 5 to FIG. 8, in an embodiment of the present application, the buckle 103 is provided on the mating port 101, a second pre-plugging latch 223 and a second electrically-plugging latch 224 are provided in the electrically-plugging port 201. The second pre-plugging latch 223 is located in the first slot section 221, the second electrically-plugging latch 224 is located in the second slot section 222, and the buckle 103 can be selectively latched onto the second pre-plugging latch 223 in a first locking position and latched onto the second electrically-plugging latch 224 in a second locking position.

In the above technical solution, the buckle 103 is an annular protrusion extending circumferentially along an edge of an end of the mating port 101, the second pre-plugging latch 223 and the second electrically-plugging latch 224 are both blockers. Two second pre-plugging latches 223 are provided, and a distance between the two second pre-plugging latches 223 is the same as the width of the buckle 103, so that the buckle 103 can be locked between the two second pre-plugging latches 223. In the process of plugging the mating port 101 into the electrically-plugging port 201, the buckle 103 first moves in the first slot section 221 from a first side of the first second pre-plugging latch 223 to a second side of the first second pre-plugging latch 223, while the buckle 103 is located on a first side of the second second pre-plugging latch 223, at this point the buckle 103 is in the first locking position. At this time, the buckle 103 is located between the two second pre-plugging latches 223, that is, the buckle 103 is latched onto the second pre-plugging latches 223, and the pre-plugging state is formed. The buckle 103 continues to move from the first side of the second second pre-plugging latch 223 to a second side of the second second pre-plugging latch 223, and at the same time, the buckle 103 enters into the second slot section 222 from the first slot section 221, and continues to move in the second slot section 222 until the buckle 103 moves from a first side of the second electrically-plugging latch 224 to a second side of the second electrically-plugging latch 224, at this point, the buckle 103 is in the second locking position. At this time, the buckle 103 is latched onto the second electrically-plugging latch 224, and the electrically-plugging state is formed. When the buckle 103 is latched onto the second pre-plugging latches 223, a safe distance is maintained between a conductive metal at an end of the electrically-plugging port 201 and a conductive metal at an end of the mating port 101 to ensure the insulation between the plug 20 and the receptacle 10.

Through the above arrangement, when the electrically-plugging port 201 is plugged into the mating port 101 and the mating port 101 is located in the first slot section 221, the second pre-plugging latches 223 can cooperate with the buckle 103 so as to lock the plug 20 onto the receptacle 10, so that the plug 20 is prevented from detaching from the receptacle 10 due to an external force such as bumping or collision during delivery, and the electrically-plugging port 201 loses the pre-plugging effect. After the electrically-plugging port 201 is plugged into the mating port 101 and the mating port 101 is located in the second slot section 222, the second electrically-plugging latch 224 is cooperated with the buckle 103 so as to lock the plug 20 onto the receptacle 10, thereby preventing safety accidents caused by the plug 20 being detached from the receptacle 10 in the high-voltage conduction process.

Referring to FIG. 5 to FIG. 8, in the second embodiment of the present application, a second unlocking member 226 is provided on the outer wall of the plug 20, the second unlocking member 226 is provided to be movable relative to the outer wall of the plug 20. The second unlocking member 226 is connected to the second pre-plugging latch 223 and the second electrically-plugging latch 224, and the second unlocking member 226 is configured to unlock the buckle 103 by sliding.

In the above technical solution, the second pre-plugging latch 223 is connected to the second electrically-plugging latch 224 to form an integrated latching structure 225, and one second unlocking member 226 is provided. The second unlocking member 226 is connected to the latching structure 225, which slidably cooperate with an inner wall of the electrically-plugging port 201, and a gap is formed between the latching structure 225 and the inner wall of the electrically-plugging port 201. When the spring is in an original length state, a gap is formed between the latching structure 225 and the inner wall of the electrically-plugging port 201, the second unlocking member 226 is slidably connected to the outer wall of the plug 20. When the latching structure 225 is moved downwardly due to an external force, the spring is compressed, and the latching structure 225 compresses the gap until the second pre-plugging latch 223 and the second electrically-plugging latch 224 leave the first slot section 221 and the second slot section 222. At this time, the mating port 101 can move smoothly along the first slot section 221 and the second slot section 222 without obstruction, i.e., the second pre-plugging latch 223 and the second electrically-plugging latch 224 no longer have a locking function, and the mating port 101 can be unplugged from or plugged into the electrically-plugging port 201. After the force applied onto the second unlocking member 226 disappears, the spring returns to its original length based on the principle of elasticity, and the latching structure 225 moves upwardly, so that the second pre-plugging latch 223 and the second electrically-plugging latch 224 respectively enter the first slot section 221 and the second slot section 222 again. The second pre-plugging latch 223 has an inclined surface on a side thereof facing an opening of the electrically-plugging port 201.

Through the above arrangement, when the electrically-plugging port 201 is plugged into the mating port 101, the buckle 103 is in contact with the inclined surface of the second pre-plugging latch 223 and moves relative to the inclined surface of the second pre-plugging latch 223, the spring is compressed, and the second pre-plugging latch 223 leaves the first slotted section 221. The buckle 103 continues to move relative to the second pre-plugging latch 223 until the second pre-plugging latch 223 is latched and connected to the buckle 103, so that when the buckle 103 is connected to the second pre-plugging latch 223, it is unnecessary to press the second unlocking member 226 due to the spring, and the second pre-plugging latch 223 is unlocked by a thrust generated by the movement. When the mating port 101 is required to enter the second slot section 222 or the electrically-plugging port 201 is required to be unplugged from the mating port 101, the second unlocking member 226 can slide downwardly, the second unlocking member 226 drives the latching structure 225 to compress the gap, and at the same time, the spring is compressed. After the second pre-plugging latch 223 leaves the first slot section 221 and the second electrically-plugging latch 224 leaves the second slot section 222, the mating port 101 can move freely relative to the first slot section 221 and the second slot section 222. The second unlocking member 226 is released after the mating port 101 is plugged into the second slot section 222 or the electrically-plugging port 201 is unplugged from the mating port 101, and the spring returns to its original length based on the principle of elasticity, so that the second pre-plugging latch 223 and the second electrically-plugging latch 224 respectively enter the first slot section 221 and the second slot section 222 again.

Referring to FIG. 5 to FIG. 8, in the second embodiment of the present application, an identification strip 104 is provided on an outer wall of the mating port 101. When the buckle 103 is located in the first locking position, the identification strip 104 is located outside the plug 20; and when the buckle 103 is located in the second locking position, the identification strip 104 is located inside the plug 20.

In the above technical solution, the identification strip 104 is annular and has a fluorescent color (for example, green), and the identification strip 104 is mounted outside the mating port 101. When the electrically-plugging port 201 is plugged into the mating port 101 to be in the pre-plugging state, i.e., when the buckle 103 is located in the first locking position, the identification strip 104 is located outside the electrically-plugging port 201 and can be seen by the installer to remind the installer that the plug is in the pre-plugging state. When the electrically-plugging port 201 is plugged into the mating port 101 to be in an electrically-plugging state, i.e., when the buckle 103 is located in the second locking position, the identification strip 104 is located inside the electrically-plugging port 201 and cannot be seen by the installer. Therefore, the identification strip 104 is configured to enable the installer to determine whether the mating port 101 and the electrically-plugging port 201 are in a pre-plugging state or an electrically-plugging state.

Through the above arrangement, the installer performing the pre-plugging operation can determine whether the mating port 101 and the electrically-plugging port 201 are in a pre-plugging state through the identification strip 104, so as to prevent the installation personnel performing the pre-plugging operation from plugging the mating port 101 and the electrically-plugging port 201 to reach an electrically-plugging state, so as to initiate a safety accident; also, the installer performing the electrically-plugging operation can determine whether the mating port 101 and the electrically-plugging port 201 are in an electrically-plugging state by means of the identification strip 104, so as to prevent the installation personnel performing the electrically-plugging operation from plugging the mating port 101 and the electrically-plugging port 201 together to reach a pre-plugging state, which cannot conduct electricity.

### Third Embodiment

The difference between the third embodiment and the second embodiment lies in the specific structure of the buckle 103 of the receptacle 10, and the plug 20 is provided with a limiter 231 and only one second pre-plugging latch 223.

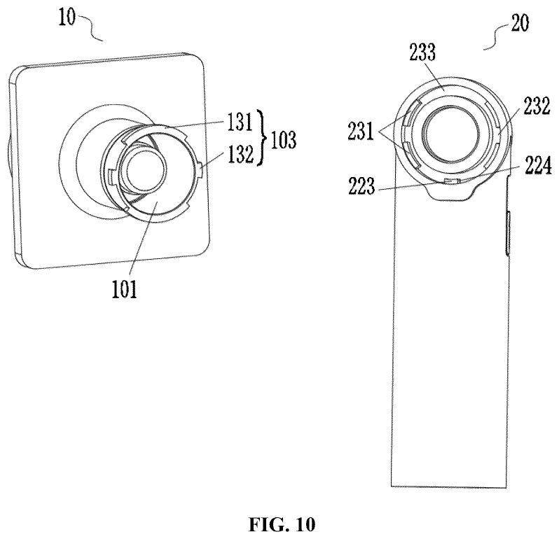

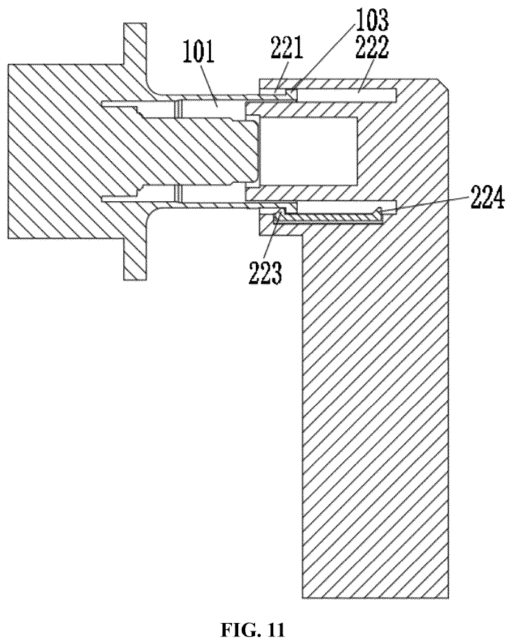

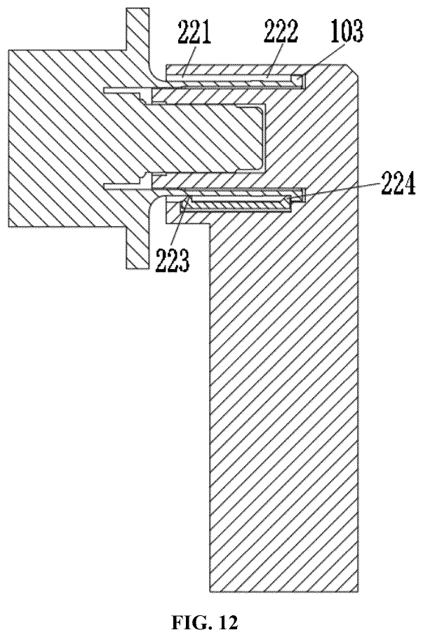

Referring to FIG. 9 to FIG. 12, in the third embodiment of the present application, a limiter 231 is provided in the electrically-plugging port 201, and the buckle 103 includes a pre-plugging limiting portion 131 and an electrically-plugging guiding portion 132 that are provided to be spaced apart in a circumferential direction of the mating port 101. The limiter 231 is configured to block the pre-plugging limiting portion 131 and not block the electrically-plugging guiding portion 132, the pre-plugging limiting portion 131 is configured to be able to be latched onto the second electrically-plugging latch 224, and the electrically-plugging guiding portion 132 is configured to be able to be latched onto the second pre-plugging latch 223.

Referring to FIG. 9 to FIG. 12, in the third embodiment of the present application, the limiter 231 includes at least two limiting blocks, a guide slot 232 is formed between the two limiting blocks. The pre-plugging limiting portion 131 and the electrically-plugging guiding portion 132 are ribs spaced circumferentially along an end of the mating port 101, and the pre-plugging limiting portion 131 has a length greater than that of the electrically-plugging guiding portion 132, and the guide slot 232 has a width smaller than the length of the pre-plugging limiting portion 131 but not smaller than the length of the electrically-plugging guiding portion 132, so that the pre-plugging limiting portion 131 cannot pass through the guide slot 232, and the electrically-plugging guiding portion 132 can pass through the guide slot 232.

In the above technical solution, the limiter 231 includes four limiting blocks, two limiting blocks form one group, and two groups of the four limiting blocks are provided opposite to each other in the electrically-plugging port 201. A guide slot 232 is formed between two limiting blocks in each group of limiting blocks, a guide gap 233 is formed between the two groups of limiting blocks, and each of the guide slot 232 and the guide gap 233 coincides with the first slot section 221 and the second slot section 222. The pre-plugging limiting portion 131 includes two ribs provided opposite to each other, and the electrically-plugging guiding portion 132 includes two ribs provided opposite to each other. The pre-plugging limiting portion 131 and the electrically-plugging guiding portion 132 are provided to be spaced apart in a staggered manner along the circumferential direction of the end of the mating port 101, the length of the pre-plugging limiting portion 131 is smaller than the length of the guide gap 233, so that the pre-plugging limiting portion 131 can be inserted into the second slot section 222 from the guide gap 233.

When the electrically-plugging port 201 is in the pre-plugging state with the mating port 101, the pre-plugging limiting portion 131 directly faces the limiting blocks, and after the electrically-plugging port 201 is inserted into the mating port 101 until the pre-plugging limiting portion 131 is in contact with the limiting blocks, the electrically-plugging port 201 cannot continue to move. At this time, the second pre-plugging latch 223 is latched onto the electrically-plugging guiding portion 132, so that the electrically-plugging port 201 and the mating port 101 are locked in the pre-plugging state. When the electrically-plugging port 201 is in the electrically-plugging state with the mating port 101, the plug 20 is axially rotated by 90°, the electrically-plugging guiding portion 132 directly faces the guide slot 232, the pre-plugging limiting portion 131 directly faces the guide gap 233, and the electrically-plugging port 201 is inserted into the mating port 101 until the electrically-plugging guiding portion 132 passes through the guide slot 232 and the pre-plugging limiting portion 131 passes through the guide gap 233. At this time, the second electrically-plugging latch 224 is latched onto the pre-plugging limiting portion 131, so that the electrically-plugging port 201 is locked in the electrically-plugging state with the mating port 101.

The structure and operation principle of the second unlocking member 226 in the third embodiment are the same as those in the second embodiment.

Through the above arrangement, the limiter 231 and the buckle 103 are designed so as to realize an accurate limitation for the pre-plugging, and it is ensured that an installer carrying out the pre-plugging operation cannot plug the electrically-plugging port 201 with the mating port 101 to be in the electrically-plugging state, thereby ensuring the safety.

Referring to FIG. 9 to FIG. 12, in the third embodiment of the present application, one second pre-plugging latch 223 is provided, which cooperates with the limiter 231 so as to be latched onto the buckle 103.

As shown in FIG. 13, the present application further provides an energy storage system. The energy storage system includes an electrical device 30, a wire 40, and the above-mentioned electrical connector, wherein there are multiple plugs 20 and multiple receptacles 10 provided in one-to-one correspondence.

It should be noted that the expression “multiple” or “plurality of” refers to two or more. The electrical device 30 is comprised of six battery packs, each battery pack is electrically connected to two receptacles 10. Multiple wires 40 are provided, the two battery packs are connected to each other by one wire 40, and two ends of each wire 40 are electrically connected to two plugs 20 respectively.

From the above description, it can be seen that the above embodiments of the present application achieve the following technical effects. The number of the plugging portion of the plug is increased or the insertion depth of the plug is changed by changing the structure of the plug, so that the plug and the receptacle can be plugged together to reach the pre-plugging state, and at this point, the plug is in an insulating connection with the receptacle. The plug and the socket can be pre-plugging together by a professional, the installer on site only is only required to switch the plug from a pre-plugging state to an electrically-plugging state with the receptacle, and then the wire 40 can be communicated, which is simple in principle, easy to operate, thereby reducing the occurrence of wrong plugging and mis-plugging.

Apparently, the embodiments described above are only some of the embodiments of the present application, rather than all of the embodiments. Any other embodiments obtained those skilled in the art based on the embodiments of the present application without creative efforts shall fall within the protection scope of the present application.

It should be noted that the terms used herein are only for the purpose of describing specific embodiments, and are not intended to limit the exemplary embodiments according to the present application. As used herein, the singular form is intended to include the plural form as well, unless explicitly indicated in the context. In addition, it should be understood that when the terms “comprising” and/or “including” are used in the specification, they indicate the presence of features, steps, operations, devices, assemblies and/or combinations of thereof.

The above embodiments are preferred embodiments of the present application, which are not intended to limit the present application, and those skilled in the art can make various modifications and variations to the present application. Any modifications, equivalent replacements and improvements made within the spirit and principles of the present application shall fall within the protection scope of the present application.

1. An electrical connector, comprising:
a receptacle, which has a mating port and a device-side interface, and the device-side interface is configured to be electrically connected to an electrical device and secured to the electrical device;
a plug, which has an electrically-plugging port and a wire interface, the plug is allowed to be plugged into the receptacle by means of the cooperation of the mating socket and the electrically-plugging port; the wire interface is configured to be electrically connected to a wire; the plug is configured to have a pre-plugging state in which the plug is in an insulating connection with the receptacle and an electrically-plugging state in which the plug is in an electrical connection with the receptacle, and in the pre-plugging state, the plug is detachably connected to the receptacle.

2. The electrical connector according to claim 1, wherein the plug further has a pre-plugging port, which is configured to be plugged into the receptacle to be in the pre-plugging state.

3. The electrical connector according to claim 2, wherein a buckle is provided on the mating port, a first pre-plugging latch is provided in the pre-plugging port, a first electrically-plugging latch is provided in the electrically-plugging port, and the buckle is allowed to be selectively latched onto the first pre-plugging latch in a first locking position, and latched onto the first electrically-plugging latch in a second locking position.

4. The electrical connector according to claim 1, wherein the electrically-plugging port has a first slot section and a second slot section that are communicated with each other, and the mating port is allowed to be selectively plugged into the first slot section to be in the pre-plugging state, and plugged into the second slot section to be in the electrically-plugging state.

5. The electrical connector according to claim 4, wherein a buckle is provided on the mating port, a second pre-plugging latch and a second electrically-plugging latch are provided in the electrically-plugging port, and the second pre-plugging latch is located in the first slot section, the second electrically-plugging latch is located in the second slot section, and the buckle is allowed to be latched onto the second pre-plugging latch in a first locking position or latched onto the second electrically-plugging latch in a second locking position.

6. The electrical connector according to claim 4, wherein a buckle is provided on the mating port, a limiter is provided in the electrically-plugging port, which is configured to prevent the buckle from being plugged into the second slot section when the plug is in the pre-plugging state.

7. The electrical connector according to claim 6, the buckle comprises a pre-plugging limiting portion and an electrically-plugging guiding portion that are provided to be spaced apart in a circumferential direction of the mating port, when the plug is in the pre-plugging state, the pre-plugging limiting portion abuts against the limiter, and the pre-plugging limiting portion and the electrically-plugging guiding portion are both located in the first slot section; and when the plug is in the electrically-plugging state, the pre-plugging limiting portion and the electrically-plugging guiding portion are both located in the second slot section; the plug is allowed to switch from the pre-plugging state to the electrically-plugging state by means of rotation and movement.

8. The electrical connector according to claim 7, wherein the limiter is provided with a guide slot, a guide gap is provided in the plug, a width of the guide slot is smaller than a length of the pre-plugging limiting portion but not smaller than a length of the electrically-plugging guiding portion, and the guide slot is configured to prevent the plugging of the pre-plugging limiting portion when the plug is in the pre-plugging state, and to allow the plugging of the electrically-plugging guiding portion; a width of the guide gap is greater than the length of the pre-plugging limiting portion and the length of the electrically-plugging guiding portion, and the guiding gap is configured to allow the plugging of the pre-plugging limiting portion and the electrically-plugging guiding portion when the plug is in the electrically-plugging state.

9. The electrical connector according to claim 3, wherein a first unlocking member is provided on an outer wall of the plug, the first unlocking member is provided to be rotatable or movable relative to the outer wall of the plug, at least two first unlocking members are provided, at least one of the first unlocking members is connected to the first pre-plugging latch, at least another one of the first unlocking members is connected to the first electrically-plugging latch, and the first unlocking member is configured to unlock the buckle by means of rotation or movement.

10. The electrical connector according to claim 5, wherein a second unlocking member is provided on an outer wall of the plug, the second unlocking member is provided to be rotatable or movable relative to the outer wall of the plug, each of the second pre-plugging latch and the second electrically-plugging latch is connected to the second unlocking member, and the second unlocking member is configured to unlock the buckle by means of rotation or movement.

11. The electrical connector according to claim 3, wherein a buckle is provided on the mating port, and an identification strip is provided on an outer wall of the mating port, when the buckle is located in the first locking position, the identification strip is located outside the plug; and when the buckle is located in the second locking position, the identification strip is located inside the plug.

12. An energy storage system, comprising an electrical device, a wire, and the electrical connector according to claim 1, wherein a plurality of plugs are provided in one-to-one correspondence to a plurality of sockets.

13. The electrical connector according to claim 5, wherein a buckle is provided on the mating port, a limiter is provided in the electrically-plugging port, which is configured to prevent the buckle from being plugged into the second slot section when the plug is in the pre-plugging state.

14. The electrical connector according to claim 5, wherein a buckle is provided on the mating port, and an identification strip is provided on an outer wall of the mating port, when the buckle is located in the first locking position, the identification strip is located outside the plug; and when the buckle is located in the second locking position, the identification strip is located inside the plug.
